(19) United States
(12) Patent Application Publication
(10) Pub. No.: US 2021/0159686 A1
(43) Pub. Date: May 27, 2021

(54) Open Heat Shrink Device

(71) Applicants: Elmer Kastelic, II, Kirtland, OH (US); Elmer C. Kastelic, III, Kirtland, OH (US)

(72) Inventors: Elmer Kastelic, II, Kirtland, OH (US); Elmer C. Kastelic, III, Kirtland, OH (US)

(21) Appl. No.: 17/101,437

(22) Filed: Nov. 23, 2020

Related U.S. Application Data
(60) Provisional application No. 62/939,430, filed on Nov. 22, 2019.

(51) Int. Cl. H02G 15/18; B32B 1/08; B32B 5/02

(52) U.S. Cl. CPC H02G 15/1813; B32B 1/08; B32B 2457/00; B32B 2307/736; B32B 5/028

(57) ABSTRACT

The open heat shrink device provides an innovative design for a tubing device, that can provide convenient means to protect an object without any cutting process. In other words, the open heat shrink tubing device provides stable and non-bulky means of attachment, such that the tubing device may be wrapped around an existing object to provide a protective covering over it, without the need to cut the object. Accordingly, the tubing device includes a wrapping member with an opening or slit that enables the wrapping member to be easily wrapped around the object that needs to be protected and/or heat shrink wrapped. Further, a plurality of fastening members enables to have a secure hold of the wrapping member around the object. Furthermore, the tubing device may include additional layers, and or textures for the wrapping member, thereby enabling an efficient and foolproof protective covering around different objects in different scenarios.

The current application claims a priority to the U.S. Provisional Patent application Ser. No. 62/939,430 filed on Nov. 22, 2019. The current application is filed on Nov. 23, 2020 while Nov. 22, 2020 was on a weekend.

### FIELD OF THE INVENTION

The present invention relates generally to a heat shrink protective device. More specifically, the present invention relates to a heat shrink panel that can be formed into a tube shape for wrapping around cables, elongated objects, an electrical power cord, or the like.

### BACKGROUND OF THE INVENTION

A protective device that can be wrapped around an electrical cord without cutting the cord is in demand. Heat shrink tubes can be used to replace tape and other wrapping materials for protecting, insulating or repairing electrical wires in cable or pipes. Currently, the object that the tube is to be wrapped around—the electrical wires to be insulated or the pipe or cable to be protected—should be cut to permit the tube to be slipped over one cut end, followed by rejoining the cut ends of the cable or pipe, then slipping the heat-shrinkable tube over the point to be repaired or covered. However, it is not practical, possible and sometimes not safe to cut and rejoin an object in order to slide a tube over it. Currently available heat-shrinkable tubes that can wrap around an object include some mechanical closures such as a metal rail or buttons to keep the two attaching faces of the tube together during the heat-shrinking process. However, in general, these provide a bulky and unstable closure or structure whose cross-sectional area is much greater than the wall thickness of the tube member; moreover, this bulky structure may cause a split or peeling of the attached two ends of the tube during the heat-shrinking process.

The present invention aims to solve and/or improve on conventional tubing devices through an innovative design to provide convenient means to protect an object without any cutting process. In other words, an objective of the present invention is to provide users with a tubing device that has stable and non-bulky means of attachment, such that the tubing device may be wrapped around an existing object (wire, pipe, or cable to be repaired) to provide a protective covering over it, without the need to cut the object. In order to accomplish that, the present invention comprises a wrapping member, which can be formed into a tubular or cylindrical shape, that enables the wrapping member to be wrapped around the object that needs to be protected and/or heat shrink wrapped. Further, the present invention comprises a plurality of fastening members and fastening technologies that enables the wrapping member to have a secure hold of around the object. Furthermore, the present invention may comprise additional layers, and or textures for the wrapping member, thereby enabling an efficient and foolproof protective covering around different objects in different scenarios.

### BRIEF DESCRIPTION OF THE DRAWINGS

FIG. 1 is a top-front-left perspective view of the present invention.

FIG. 2 is a front elevational view of the present invention.

FIG. 3 is a detailed view of section 3 in FIG. 2.

FIG. 4 is a bottom-rear-right perspective view of the present invention.

FIG. 5 is a top-front-left perspective view of the present invention, wherein the fastening members are unfastened, and the heat shrink tube is open.

FIG. 6 is a front elevational view of the present invention wherein the heat shrink tube is open.

FIG. 7 is a detailed view of section 7 in FIG. 6.

FIG. 8 is a detailed view of section 8 in FIG. 6.

FIG. 9 is a top-front-left perspective view of the present invention wherein fastening members are non-continuous.

FIG. 10 is a detailed view of section 10 in FIG. 9.

FIG. 11 is a top-front-left perspective view, wherein the present invention with segmented fastening members are wrapped around an object (broken lines) just before heat shrinking.

FIG. 12 is a top-front-left perspective view, wherein the present invention is heat shrunk around the object.

FIG. 13 is a top-front-right perspective view wherein the flexible panel comprises a mesh surface and an isolation layer.

### DETAIL DESCRIPTIONS OF THE INVENTION

All illustrations of the drawings are for the purpose of describing selected versions of the present invention and are not intended to limit the scope of the present invention.

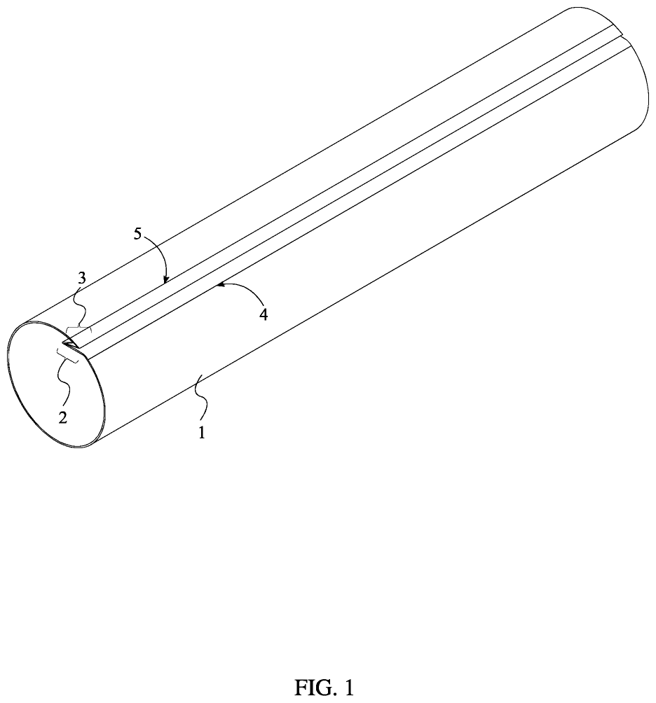

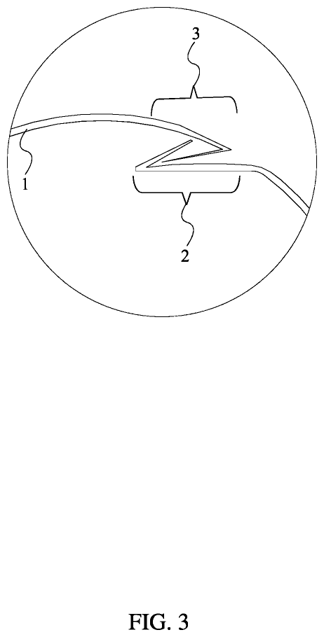

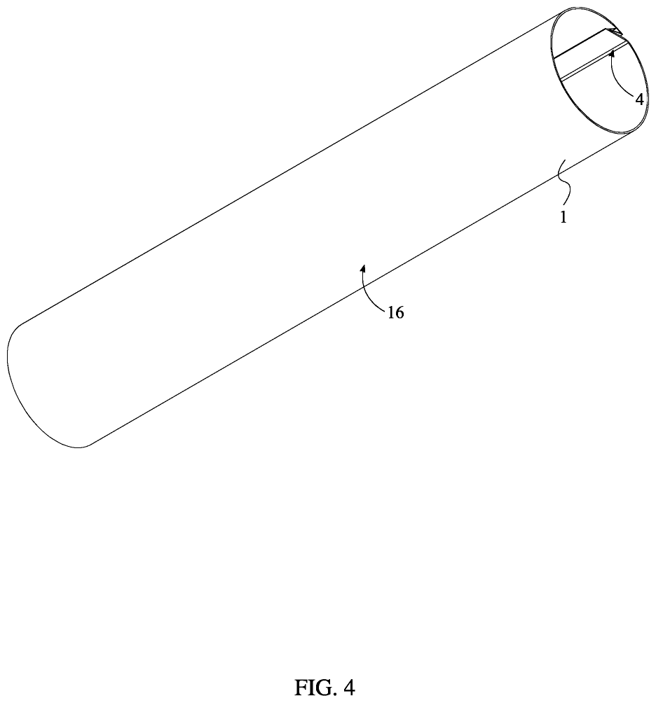

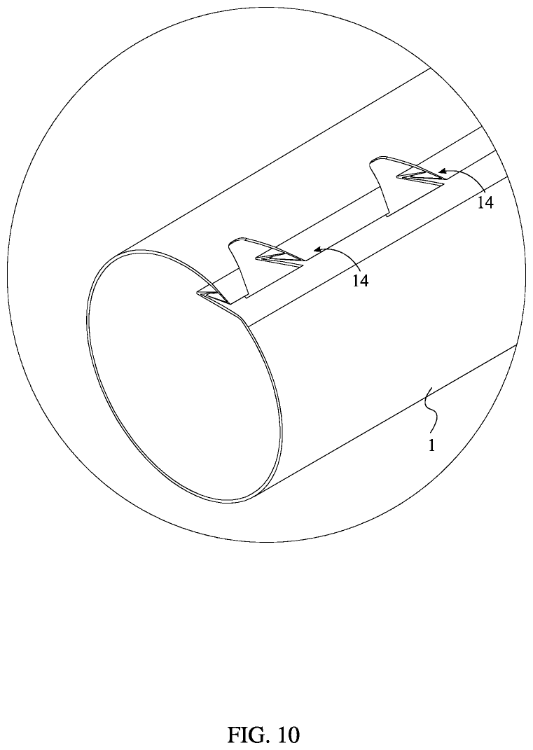

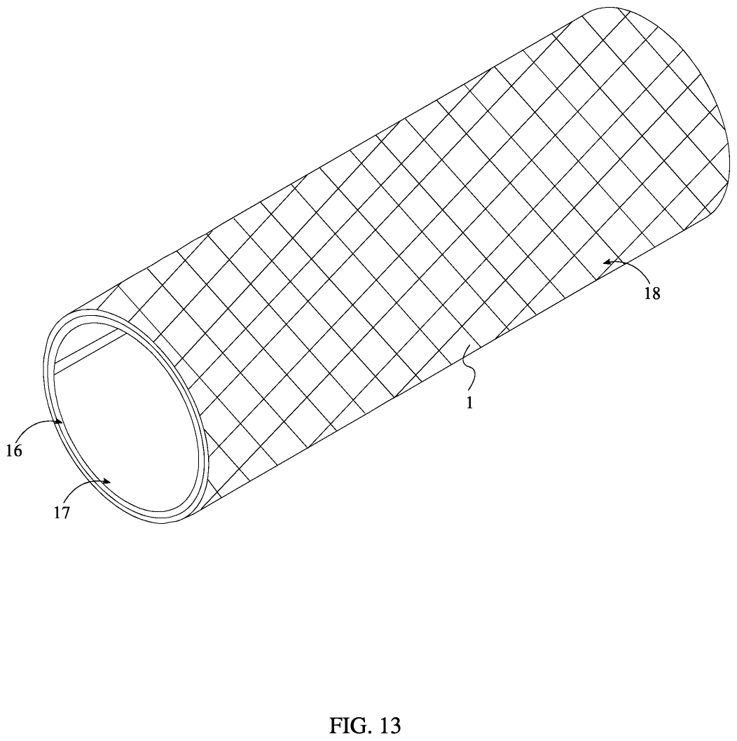

In reference to FIG. 1 through FIG. 13, the present invention is an open heat shrink device. The present invention provides a heat shrink tube with an innovative means of attachment. The present invention can be used to surround an electrical wire, forming new insulation over a damaged, spliced, or repaired area. Compared to conventional heat shrink tubing, the present invention does not start out as a complete tube, allowing installation over an existing wire. Thus, the wire does not have to be cut or have either end disconnected. To that end, rather than comprising a complete cylinder or tube in shape, the present invention is an open tube that becomes fully cylindrical once it has been installed around a wire and its lengthwise edges have interlocked with one another. Further, the present invention, which can be used mostly by electrical and electronics repair persons, can be applied simply by wrapping the material around a wire, then interlocking the edges of the present invention together, then applying heat with a heat gun or other source to shrink the tube thus formed to cause it to fit tightly around the surrounded wire. Thus, the present invention aims to solve and/or improve on conventional tubing devices through an innovative device designed to provide convenient means to protect an object without any cutting process.

The following description is in reference to FIG. 1 through FIG. 13. According to a preferred embodiment of the present invention, the open heat shrink device comprises a flexible panel 1, a first fastening member 2, and a second fastening member 3. Preferably, the flexible panel 1 is made of plastic or any suitable material or a combination of materials that can conform to the size and shape of the object enclosed by the flexible panel 1. In other words, the flexible panel 1 comprises a flexible material that may be placed on and wrapped around an object. Further, it is preferred that the flexible panel 1 is heat shrinkable. In one embodiment, the flexible panel 1 may be a shrinkable plastic tube that contracts strongly under the action of heat. The maximum size change of the flexible panel 1 during shrinkage may depend on the plastic used. Preferably, the common size changes (shrink ratios) are 2:1 to 6:1. Thus, the original size of the flexible panel 1 can be larger than the desired size, considering the change in size after shrinkage. However, the flexible panel 1 may comprise any shape, size, material, components and arrangement of components as long as the objectives of the present invention are fulfilled.

In the preferred embodiment, the first fastening member 2 and the second fastening member 3 provide a fastening mechanism to secure the flexible panel 1 on the object that needs to be covered and protected. In order to accomplish this, the first fastening member 2 is attached along a first mounting edge 4 of the flexible panel 1 and the second fastening member 3 is attached along a second mounting edge 5 of the flexible panel 1. Preferably, the first mounting edge 4 is positioned opposite to the second mounting edge 5 across the flexible panel 1, such that positioning of the first fastening member 2 and the second fastening member 3 facilitate the fastening of the flexible panel 1 onto an object such as an electrical wire. In other words, this arrangement enables the flexible panel 1 to enclose the wire to be protected or heat shrunk efficiently. Further, the first fastening member 2 and the second fastening member 3 are interlocking members, wherein the first fastening member 2 is removably engaged with the second fastening member 3. Thus, the first fastening member 2 and the second fastening member 3 enables a user to wrap the flexible member 1 around the object through the opening between the first mounting edge 4 and the second mounting edge 5 without any cutting of the object or the flexible panel 1. Following the wrapping process, the first fastening member 2 and the second fastening member 3 are interlocked or fastened to ensure proper securing of the flexible panel 1 around the object that needs protection or mending.

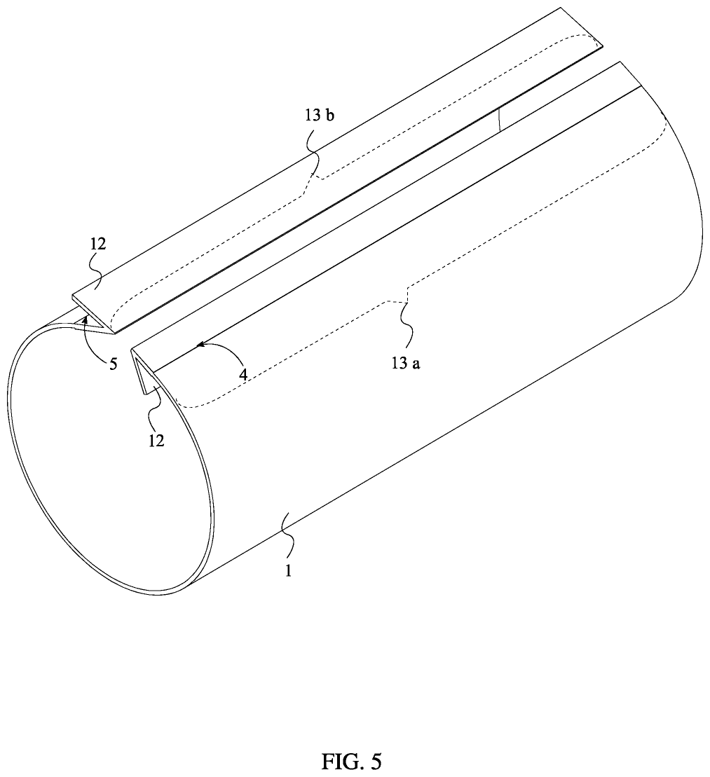

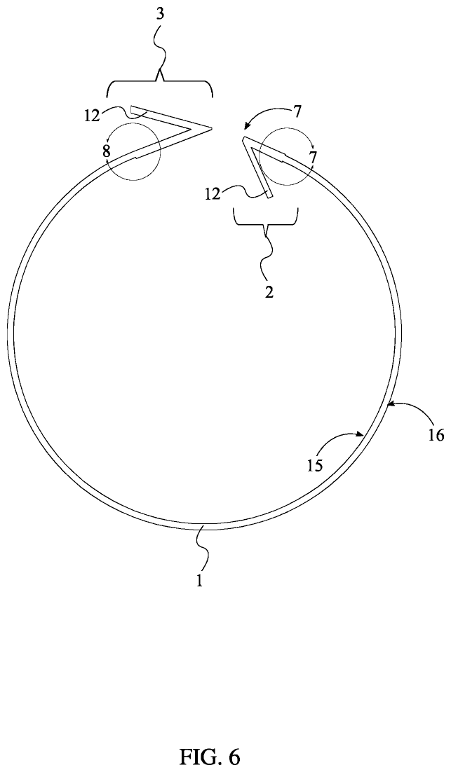

As seen in FIG. 1 through FIG. 4, the first fastening member 2 is oriented toward an exterior surface of the flexible panel 1 and the second fastening member 3 is oriented toward an interior surface of the flexible panel 1. In reference to FIG. 5 and FIG. 6, the first fastening member 2 is oriented toward an interior surface of the flexible panel 1 and the second fastening member 3 is oriented toward an exterior surface of the flexible panel 1. Accordingly, it should be noted that the first fastening member 2 and the second fastening member 3 may comprise any other shape, size, technology, orientation, components and arrangement of components as long as the intents of the present invention are not altered.

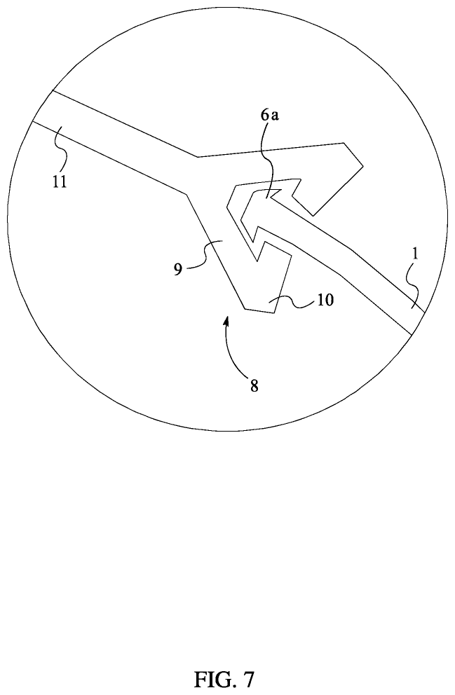

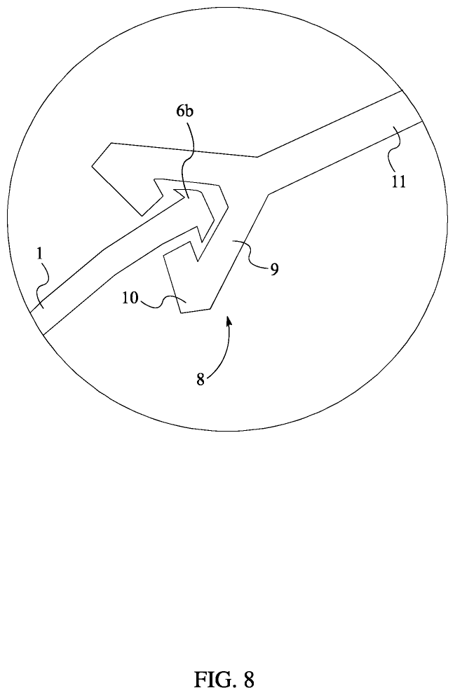

According to the preferred embodiment, the first fastening member 2 and the second fastening member 3 may be positioned coextensive to the flexible panel 1 as seen in FIG. 1 through FIG. 4, or the wrapping member (flexible panel 1) and the fastening members may comprise additional fastening components between them. To that end, as seen in FIG. 5 through FIG. 8, the heat shrink device comprises a first intermediate connector 6a, wherein the first intermediate connector 6a is connected in between the first fastening member 2 and the first mounting edge 4. In other words, the first intermediate connector 6a constitutes an edge of the flexible panel 1 that is shaped in such a way that the edge can dovetail with a latch of the first fastening member 2. Similarly, a second intermediate connector 6b is connected in between the second fastening member 3 and the second mounting edge 5. In other words, the second intermediate connector 6b constitutes an edge of the flexible panel 1 that is shaped in such a way that the edge can dovetail with a latch of the second fastening member 3 to form a dovetail joint. This arrangement is so that the dovetail joint between each of the first fastening member 2 and the second fastening member 3, and the flexible panel 1 may allow the shrink tube device to have the necessary shrinking properties when heated while permitting the latching edges to remain latched and hold tension so that the surface of the dovetail joint area can be flatly attached on the wire or object being protected. To that end, the first fastening member 2 and the second fastening member 3 each comprises a fastener coupler 7 and a panel coupler 8, wherein the panel coupler 8 is connected adjacent to the fastener coupler 7. Preferably, the panel coupler 8 of the first fastening member 2 is detachably coupled to the first mounting edge 4, and the panel coupler 8 of the second fastening member 3 is detachably coupled to the second mounting edge 5. As seen in FIG. 7, the panel coupler 8 of the first fastening member comprises a receptacle 9 and at least one retention member 10. The receptacle 9 acts as the open area that receives the edge of the flexible panel 1. In other words, the first intermediate connector 6a is inserted into the receptacle 9, thereby facilitating a dovetail joint between the first mounting edge 4 and the first fastening member 2. Similarly, as seen in FIG. 8, the second intermediate connector 6b is inserted into the receptacle 9, thereby facilitating a dovetail joint between the second mounting edge 5 and the second fastening member 3. Preferably the retention member 10 is mounted around an opening of the receptacle 9 and the retention member 10 is positioned opposite to the fastener coupler 7 across the panel coupler 8. This is so that the retention member 10 holds the flexible panel 1 in place. Further, as seen in FIG. 7 and FIG. 8, the fastener coupler 7 comprises a standoff 11 and at least one interlocking member 12, such that the standoff 11 and the at least one interlocking member 12 enable interlocking of the first fastening member 2 and the second fastening member 3. Preferably, the standoff 11 is connected in between the panel coupler 8 and the interlocking member 12, as seen in FIG. 6. However, it should be noted that the panel coupler 8 and the fastener coupler 7 may comprise any other shape, size, components and arrangement of components that are known to one of ordinary skill in the art, as long as the objectives of the present invention are not hindered. In an alternate embodiment, the fastener coupler 7 and the panel coupler 8 may comprise a material different from that of the flexible panel 1.

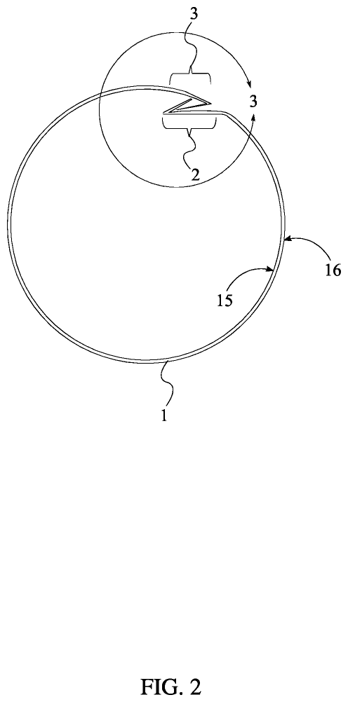

In reference to FIG. 5 and FIG. 6, the first fastening member 2 and the second fastening member 3 comprise a V-shape in its cross-section. The V-shaped folded ends can be interlocked and bonded lengthwise to the body of the shrink tube device, allowing the shrink tube device to be installed around a wire or object without cutting the wire or object. Further, as seen in FIG. 5, the first fastening member 2 extends continuously along a first length 13a of the first mounting edge 4 and the second fastening member 3 extends continuously along a second length 13b of the second mounting edge 5. In other words, when the V-shaped folded ends are bonded lengthwise to the body of the shrink tube device, one surface (which can be an upper surface) of the shrink tube device (or flexible panel 1) may overlap the other surface (which may be a lower surface). As can be seen in FIG. 2, the lower surface, in the overlapping area may provide an extra surface to cover the wire when the flexible panel 1 (wrapping member) is shrunken to size. However, it should be noted that the first fastening member 2 and the second fastening member 3 may have any other suitable cross-sectional shapes.

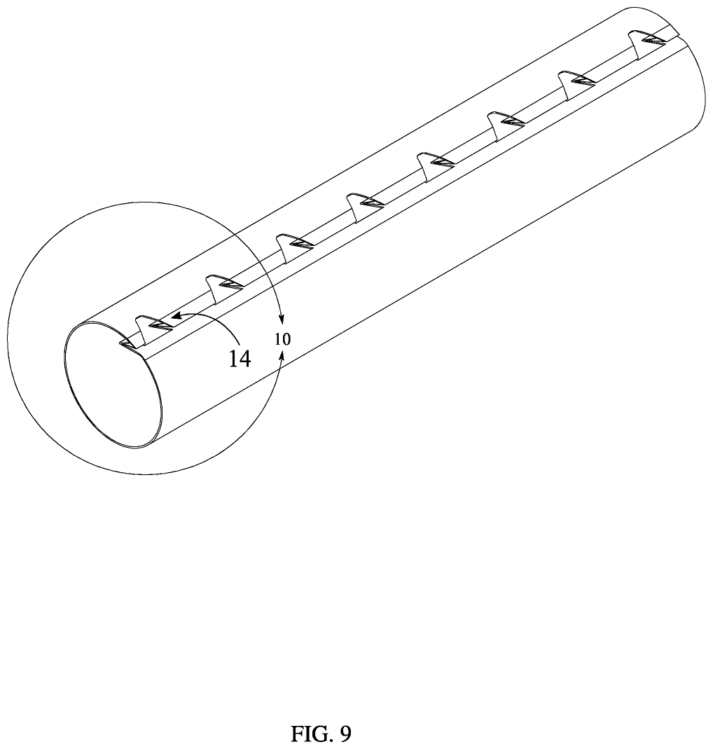

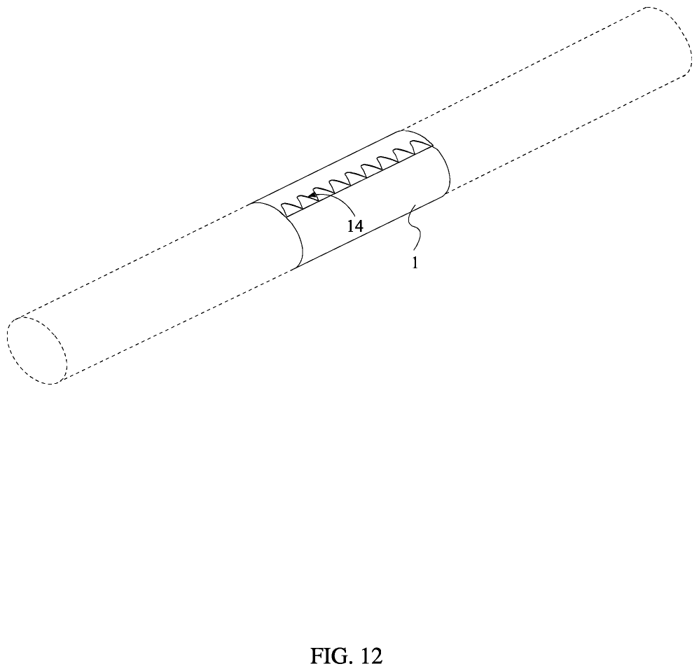

In reference to FIG. 9 and FIG. 12, at least one of the first fastening member 2 and the second fastening member 3 is non-continuous. In other words, the first fastening member 2 and the second fastening member 3 include a segmented shape attached along the length of the flexible panel 1. As seen in FIG. 9, at least one of the first fastening member 2 and the second fastening end 3 comprise a plurality of serrated folded edges 14. This is so that the folded end attached along the length of the flexible panel 1 provides a non-continuous attachment surface that may allow greater shrinkage without bunching. As seen in FIG. 12, the plurality of serrated folded edges after shrinking, provides a perfectly wrapped heat shrunk surface to the object (broken lines) without any bunching. Further at least one of the first fastening member 2 and the second fastening member 3 may also include a number of separate pieces having a curved or irregular shape or any other design along the length of the flexible panel 1 and on the surface around the first mounting edge 4 and the second mounting edge 5.

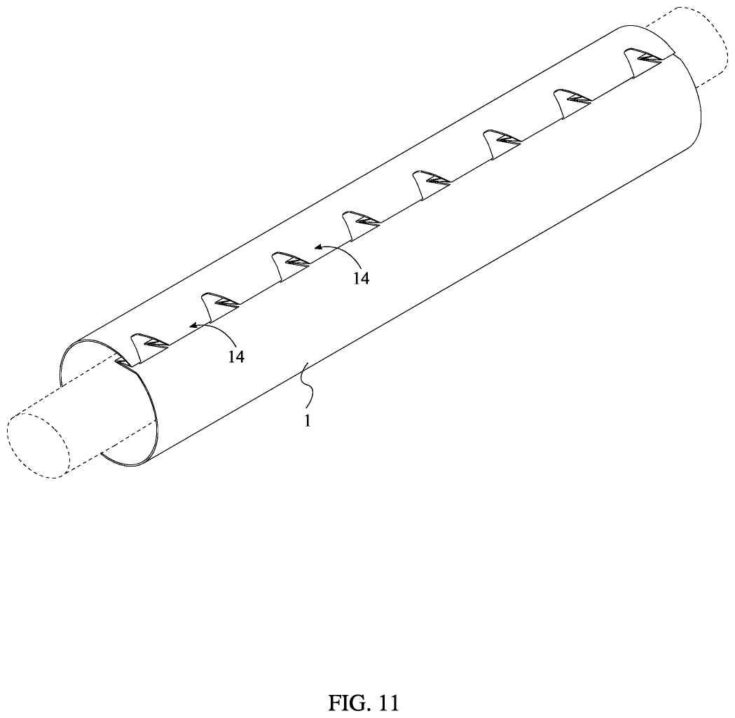

According to the preferred embodiment of the present invention, the flexible panel 1 is a rectangle in shape. Preferably, as seen in FIG. 1, and FIG. 5, the first mounting edge 4 and the second mounting edge 5 are positioned along longer edges of the rectangle. This is so that the fastening members may be attached to two opposing edges of the flexible panel 1 and may extend substantially all the way across the flexible panel 1 along the longitudinal axis, substantially parallel to the length of a wire or object wrapped around by the flexible panel 1, to provide a secure attachment of the flexible panel 1 when wrapped around the object. However, the first mounting edge 4 and the second mounting edge 5 may be positioned along any edges of the flexible panel 1, as long as the objectives of the present invention are fulfilled. Further, according to the preferred embodiment, at least one of the first fastening member 2 and the second fastening member 3 is heat shrinkable. This is so that heat shrinking the present invention around the object leads to a perfect shrink and perfect bond even around the interlocking region of the first fastening member 2 and the second fastening member 3, thereby leading to perfect sealing and protection of the object. As seen in FIG. 11 and FIG. 12, the heat shrunk flexible panel 1 and the heat shrunk fastening members provide a perfect wrapped and protected surface around the object (broken lines). However, at least one of the first fastening member 2 and the second fastening member 3 may comprise any other material and material properties, as long as the intents of the present invention are fulfilled.

Continuing with the preferred embodiment, the open heat shrink device further comprises an interior surface 15 and an exterior surface 16. Preferably the interior surface 15 is positioned opposite to the exterior surface 16 across the flexible panel 1. In some embodiments, the flexible panel 1 may include an additional coating on the inside with a hot-melt adhesive or sealant. Accordingly, as seen in FIG. 12, the flexible panel 1 comprises a sealant layer 17, wherein the sealant layer 17 is mounted onto the interior surface 15. As an alternative to coating, a separate layer of heat-resistant sealant could be applied to the object to be wrapped, followed by wrapping and shrinking of the flexible panel 1, resulting in consolidation of the sealant and the flexible panel 1. In some embodiments, the flexible panel 1 can also be used as insulation against current flow, moisture and water.

In reference to FIG. 12, the flexible panel comprises a reinforcing mesh layer 18, wherein the reinforcing mesh layer 18 is mounted onto the exterior surface 16. This is so that the reinforcing mesh layer may increase the mechanical strength of the flexible panel 1. Further, in alternate embodiment, the flexible panel 1 is a mesh layer, wherein the flexible panel 1 is used to provide containment only and full surrounding is not desired.

Although the invention has been explained in relation to its preferred embodiment, it is to be understood that many other possible modifications and variations can be made without departing from the spirit and scope of the invention as hereinafter claimed.

What is claimed is:

1. An open heat shrink device, comprising:
a flexible panel;
a first fastening member;
a second fastening member;
the first fastening member being attached along a first mounting edge of the flexible panel;
the second fastening member being attached along a second mounting edge of the flexible panel;
the first mounting edge being positioned opposite to the second mounting edge across the flexible panel;
the first fastening member and the second fastening member being interlocking members; and
the flexible panel being heat shrinkable.

2. The open heat shrink device of claim 1, comprising:
the first fastening member being oriented toward an interior surface of the flexible panel; and
the second fastening member being oriented toward an exterior surface of the flexible panel.

3. The open heat shrink device of claim 1, comprising:
a first intermediate connector; and
the first intermediate connector being connected in between the first fastening member and the first mounting edge.

4. The open heat shrink device of claim 1, comprising:
a second intermediate connector; and
the second intermediate connector being connected in between the second fastening member and the second mounting edge.

5. The open heat shrink device of claim 1, comprising:
the first fastening member and the second fastening member each comprising a fastener coupler and a panel coupler;
the panel coupler being connected adjacent to the fastener coupler;
the panel coupler of the first fastening member being detachably coupled to the first mounting edge; and
the panel coupler of the second fastening member being detachably coupled to the second mounting edge.

6. The open heat shrink device of claim 5, comprising:
the panel coupler comprising a receptacle and at least one retention member;
the retention member being mounted around an opening of the receptacle; and
the retention member being positioned opposite to the fastener coupler across the panel coupler.

7. The open heat shrink device of claim 5, comprising:
the fastener coupler comprising a standoff and at least one interlocking member; and
the standoff being connected in between the panel coupler and the interlocking member.

8. The open heat shrink device of claim 1, wherein the first fastening member and the second fastening member comprise a V-shape.

9. The open heat shrink device of claim 1, comprising:
the first fastening member extending continuously along a first length of the first mounting edge; and
the second fastening member extending continuously along a second length of the second mounting edge.

10. The open heat shrink device of claim 1, wherein at least one of the first fastening member and the second fastening member being non-continuous.

11. The open heat shrink device of claim 10, wherein at least one of the first fastening member and the second fastening end comprising a plurality of serrated folded edges.

12. The open heat shrink device of claim 1, wherein the flexible panel is a rectangle in shape.

13. The open heat shrink device of claim 12, wherein, the first mounting edge and the second mounting edge are positioned along longer edges of the rectangle.

14. The open heat shrink device of claim 1, wherein at least one of the first fastening member and the second fastening member is heat shrinkable.

15. The open heat shrink device of claim 1, comprising:
an interior surface;
an exterior surface;
a sealant layer;
the interior surface being positioned opposite to the exterior surface across the flexible panel; and
the sealant layer being mounted onto the interior surface.

16. The open heat shrink device of claim 15, comprising:
a reinforcing mesh layer; and
the reinforcing mesh layer being mounted onto the exterior surface.

17. The open heat shrink device of claim 1, wherein the flexible panel is a mesh layer.
